(19) United States
(12) Patent Application Publication
(10) Pub. No.: US 2012/0033879 A1
(43) Pub. Date: Feb. 9, 2012

(54) BINARIZING DEVICE, IMAGE PROCESSING APPARATUS, COMPUTER READABLE MEDIUM FOR BINARIZING, COMPUTER DATA SIGNAL FOR BINARIZING AND METHOD FOR BINARIZING

(75) Inventor: Atsushi ITOH, Kanagawa (JP)

(73) Assignee: FUJI XEROX CO., LTD., Tokyo (JP)

(21) Appl. No.: 13/033,263

(22) Filed: Feb. 23, 2011

(30) Foreign Application Priority Data
Aug. 3, 2010 (JP) 2010-174787

(51) Int. Cl. G06K 9/46

(52) U.S. Cl. 382/166

(57) ABSTRACT

A binarizing device includes: a displacement calculating unit that calculates a displacement of a value of a pixel of interest in a local region which includes the pixel of interest and indicates a predetermined range; an N-arization unit that changes the displacement calculated by the displacement calculating unit to an N-ary value; and a selection/binarization unit that selects at least one of a fixed value or an average value of the local region as a threshold value according to the N-ary value obtained by the N-arization unit and binarizes the value of the pixel of interest.

### CROSS-REFERENCE TO RELATED APPLICATION

This application is based on and claims priority under 35 USC 119 from Japanese Patent Application No. 2010-174787 filed on Aug. 3, 2010.

### BACKGROUND

1. Technical Field

The present invention relates to a binarizing device, an image processing apparatus, a computer readable medium for binarizing, a computer data signal for binarizing, and a method for binarizing.

2. Related Art

In recent years, a monochrome image or a color image has been binarized such that the amount of data is less than that of the original image and the binarized image has been stored or used for other purposes. In a general binarizing technique, a portion with a density greater than that of other portions is allocated to one of two values, and a portion with a density less than that of other portions is allocated to the other value. Therefore, when higher-density information is included in a background with a density greater than that of other portions, the portions have one of the two values. Of course, even when information with a density less than that of other portions is included in a low-density background, the portions have the other value.

### SUMMARY

According to an aspect of the invention, there is provided a binarizing device including: a displacement calculating unit that calculates a displacement of a value of a pixel of interest in a local region which includes the pixel of interest and indicates a predetermined range; an N-arization unit that changes the displacement calculated by the displacement calculating unit to an N-ary value; and a selection/binarization unit that selects at least one of a fixed value or an average value of the local region as a threshold value according to the N-ary value obtained by the N-arization unit and binarizes the value of the pixel of interest.

### BRIEF DESCRIPTION OF THE DRAWINGS

Exemplary embodiments of the present invention will be described in detail based on the following figures, wherein:

FIG. 1 is a diagram illustrating the structure of a first exemplary embodiment of the invention;

FIGS. 2A to 2F are diagrams illustrating an example of the operation of the first exemplary embodiment of the invention;

FIG. 3 is a diagram illustrating the structure of a second exemplary embodiment of the invention;

FIGS. 4A to 4D are diagrams illustrating an example of the operation of the second exemplary embodiment of the invention;

FIGS. 5A to 5D are diagrams illustrating another example of the operation of the second exemplary embodiment of the invention;

FIG. 6 is a diagram illustrating the structure of a third exemplary embodiment of the invention;

FIGS. 7A to 7H are diagrams illustrating an example of the operation of the third exemplary embodiment of the invention; and

FIG. 8 is a diagram illustrating an example of a computer program for implementing the functions according to each exemplary embodiment of the invention, a storage medium that stores the computer program, and a computer.

### DETAILED DESCRIPTION

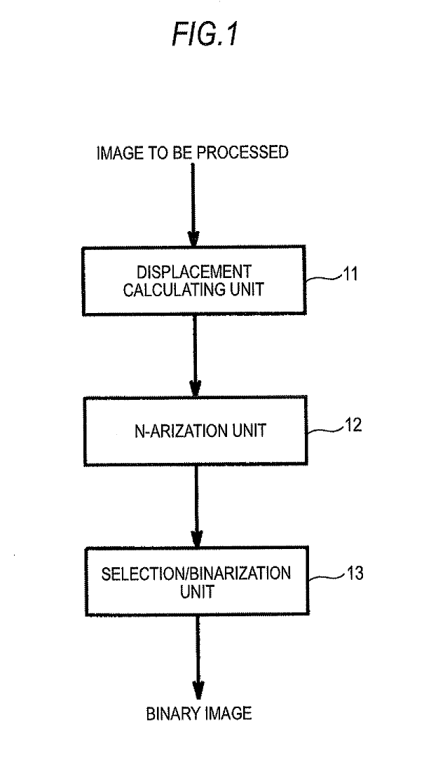

FIG. 1 is a diagram illustrating the structure of a first exemplary embodiment of the invention. In FIG. 1, reference numeral 11 indicates a displacement calculating unit, reference numeral 12 indicates an N-arization unit, and reference numeral 13 indicates a selection/binarization unit. When an image to be processed is given, each pixel is sequentially binarized as a pixel of interest.

The displacement calculating unit 11 calculates the displacement of the value of the pixel of interest in a local region that includes the pixel of interest and is within a predetermined range. A sign is added to the displacement. When the value of the pixel of interest is smaller than the value of another pixel in the local region, one sign is added to indicate a large absolute value. When the value of the pixel of interest is greater than the value of another pixel in the local region, the other sign is added to indicate a large absolute value. Examples of the displacement include the average value of the values of the pixels in the local region and the difference between a quadratic differential value and the value of the pixel of interest. Examples of the value of the pixel include density, brightness, chroma, a color, and a color value. The local region may have a sufficient size to capture a single-boundary structure, such as a texture image, and a size required to maintain the reproduction of the boundary. In addition, the local region may have a size that does not include peripheral boundaries with different characteristics.

The N-arization unit 12 compares the displacement calculated by the displacement calculating unit 11 with N−1 predetermined threshold values to change the displacement into an N-ary value (where N is an integer equal to or greater than 3).

The selection/binarization unit 13 selects at least one of a fixed value or the average value in the local region as the threshold value according to the N-ary value obtained by the N-arization unit 12 and binarizes the value of the pixel of interest.

The N-arization unit 12 may not create an N-ary image, but may output the comparison result of the threshold value. Then, the selection/binarization unit 13 may receive the comparison result and select the threshold value.

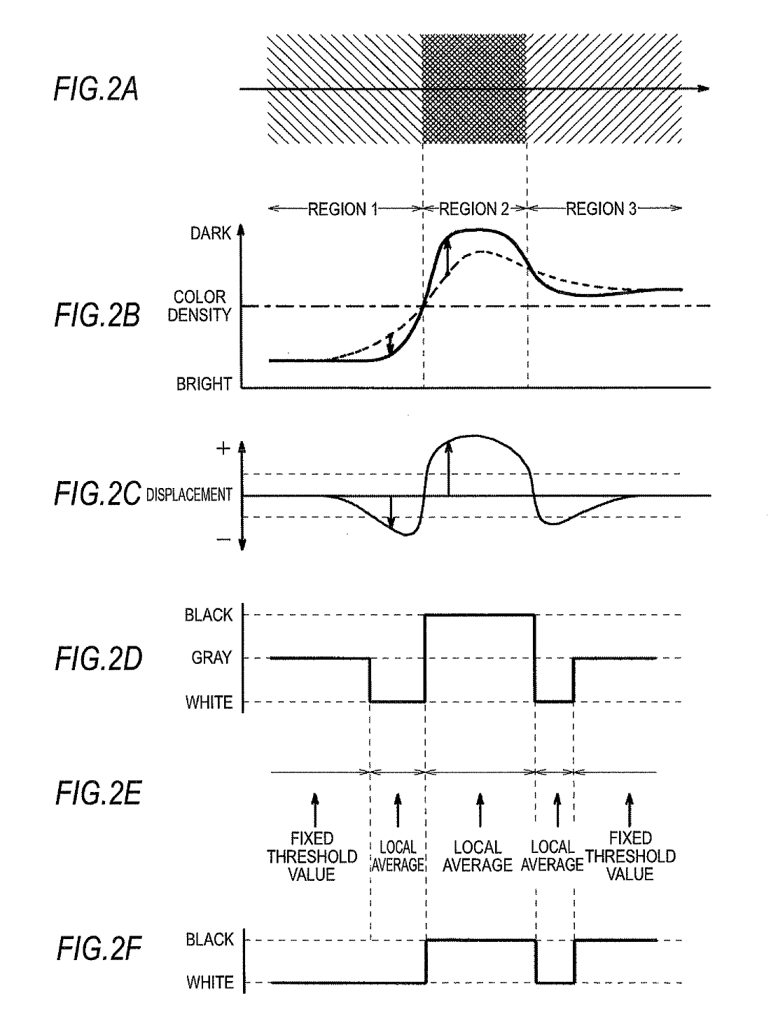

FIGS. 2A to 2F are diagrams illustrating an example of the operation of the first exemplary embodiment of the invention. FIG. 2A partially shows an example of the image to be processed. In this example, a region 1, a region 2, and a region 3 have different colors. FIG. 2B shows a variation in color density (brightness) that is represented by an arrow in FIG. 2A. The color density of the region 1 is less than those of the region 2 and the region 3, and the color density of the region 2 is more than those of the region 1 and the region 3.

The displacement calculating unit 11 calculates the displacement of the value of the pixel of interest in a local region. In this exemplary embodiment, the displacement calculating unit 11 calculates the average value of the color density of the local region and uses the difference between the average value and the value of the color density of the pixel of interest as the displacement. In FIG. 2B, the average value of the color density of the local region is represented by a dashed line. In FIG. 2B, the difference between the average value of the color density and the values of the color densities of two pixels of interest is represented by an arrow, which is the displacement. An example of the displacement is shown in FIG. 2C. When the color density of the pixel of interest is less than the average value, a sign “−” is given. When the color density of the pixel of interest is more than the average value, a sign “÷” is given.

The N-arization unit 12 changes the displacement into an N-ary value (in this exemplary embodiment, a ternary value). The N-arization unit 12 changes the displacement shown in FIG. 2C into a ternary value using two predetermined threshold values. An example of the ternary value is shown in FIG. 2D. In the example shown in FIG. 2D, three values are represented by white, gray, and black.

The selection/binarization unit 13 selects the threshold value according to the ternary value and binarizes the value of the pixel of interest. In this exemplary embodiment, in the white and black regions among the three values, the average value of the color density of the local region is selected as the threshold value and the value of the pixel of interest is binarized. In the gray region among the three values, a predetermined fixed threshold value is selected and the value of the pixel of interest is binarized. The selected threshold values are shown in FIG. 2E.

In the region in which the average value of the color density of the local region is selected as the threshold value, binarization may be performed according to whether the color density is less or more than the average value represented by a dashed line in FIG. 2B. In this exemplary embodiment, when the color density of the pixel of interest is less than the average value, which is the threshold value, white, which is one of two values, is selected. When the color density of the pixel of interest is more than the average value, which is the threshold value, black, which is the other one of the two values, is selected.

In the region in which the fixed threshold value is selected, binarization may be performed according to whether the color density is less or more than the fixed threshold value represented by a one-dot chain line in FIG. 2B. In this exemplary embodiment, when the color density of the pixel of interest is less than the fixed threshold value, white, which is one of two values, is selected. When the color density of the pixel of interest is more than the fixed threshold value, black, which is the other one of the two values, is selected.

The binarization result is shown in FIG. 2F. For example, when binarization is performed using the fixed threshold value represented by the one-dot chain line in FIG. 2B, the region 2 and the region 3 are binarized to black and the region 2 is not discriminated from the region 3. However, since the region binarized to white is generated at the boundary between the region 2 and the region 3, the region 2 and the region 3 are discriminated. In addition, binarization to black indicates that the color density of the region 2 and the region 3 is more than the fixed threshold value.

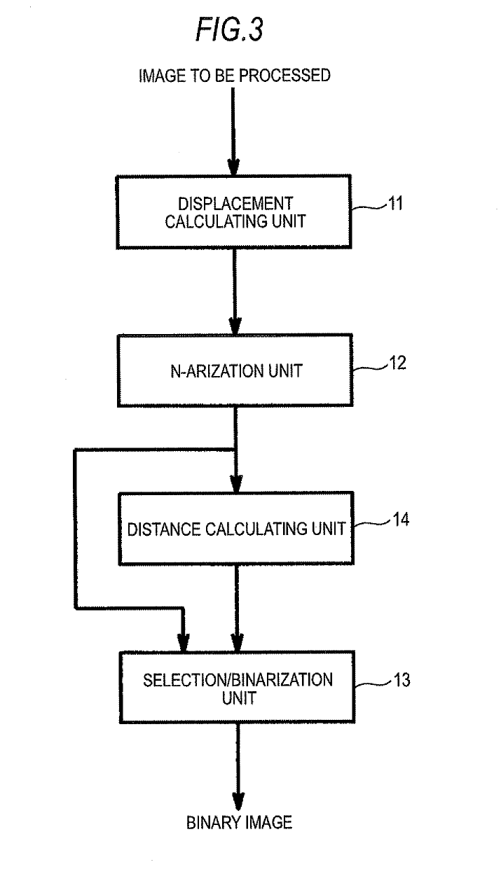

FIG. 3 is a diagram illustrating the structure of a second exemplary embodiment of the invention. In FIG. 3, reference numeral 14 indicates a distance calculating unit. In the second exemplary embodiment, the distance calculating unit 14 is provided in addition to the structure of the first exemplary embodiment.

The distance calculating unit 14 calculates the distance from a specific value of the N-ary values obtained by the N-arization unit 12 to the pixel of interest. The specific value of the N values may be one or both of the maximum value and the minimum value of the N-ary values. For example, the number of pixels may be used instead of the distance.

In the second exemplary embodiment, the selection/binarization unit 13 selects a threshold value for binarization according to the N-ary value obtained by the N-arization unit 12 and the distance calculated by the distance calculating unit 14. Specifically, the threshold value is selected from the N-ary value, but when the sign of the displacement of the boundary is reverse to the sign of the displacement of the pixel of interest during the calculation of the distance in a predetermined range of the distance, the threshold value is corrected such that the sign thereof is reverse to the sign of the displacement of the pixel of interest. In some cases, the binarization result is inverted by the correction of the threshold value, which causes information to appear. Since the distance is within a predetermined range, the binarization result is inverted in a region having the range as its width.

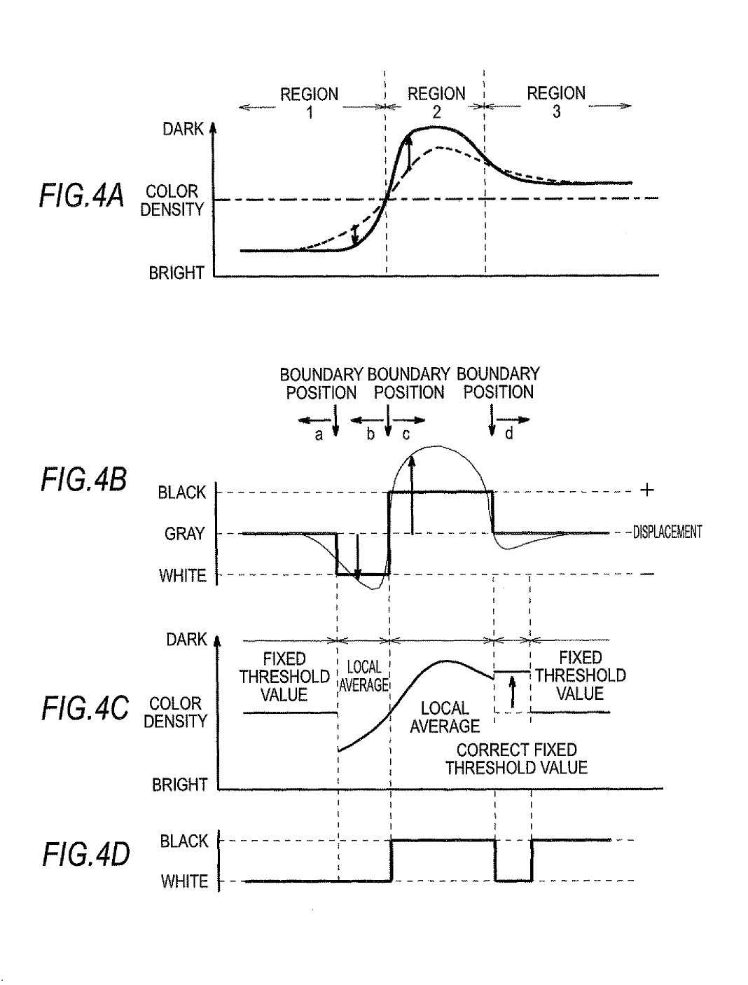

FIGS. 4A to 4D are diagrams illustrating an example of the operation of the second exemplary embodiment of the invention. FIG. 4A partially shows an example of a variation in color density in an image to be processed, and the variation in color density is represented by a solid line. In this example, a region 1, a region 2, and a region 3 have different colors. The color density of the region 1 is less than that of the region 2 and the region 3, and the color density of the region 2 is more than that of the region 1 and the region 3.

The displacement calculating unit 11 calculates the displacement of the value of the pixel of interest in a local region. In this exemplary embodiment, the displacement calculating unit 11 calculates the average value of the color density of the local region and uses the difference between the average value and the value of the color density of the pixel of interest as the displacement. In FIG. 4A, the average value of the color density of the local region is represented by a dashed line. In FIG. 4A, the difference between the average value of the color density and the values of the color densities of two pixels of interest is represented by an arrow, which is the displacement. An example of the displacement shown in FIG. 4B is represented by a thin line. When the color density of the pixel of interest is less than the average value, a sign “−” is given. When the color density of the pixel of interest is more than the average value, a sign “+” is given.

The N-arization unit 12 changes the displacement into an N-ary value (in this exemplary embodiment, a ternary value). The N-arization unit 12 changes the displacement shown in FIG. 4B into a ternary value using two predetermined threshold values (represented by a dashed line). The ternary value is represented by a solid line in FIG. 4B. In the example shown in FIG. 4B, three values are represented by white, gray, and black. In this case, the sign of the displacement of black is positive and the sign of the displacement of white is negative. In addition, black and white are the maximum and minimum values of the three values.

The distance calculating unit 14 calculates a specific N-ary value obtained by the N-arization unit 12. In this exemplary embodiment, the distance calculating unit 14 calculates the distance from the boundary between black and white to the pixel of interest. In FIG. 4B, the boundary position between black and white is represented by an arrow, and the distance calculating unit 14 calculates the distance from the boundary position to different ternary values.

The selection/binarization unit 13 selects a threshold value according to the ternary value and binarizes the value of the pixel of interest. In this exemplary embodiment, in the white and black regions among the three values, the average value of the color density of the local region is selected as the threshold value. In the gray region among the three values, a predetermined fixed threshold value is selected. In the gray region, when the distance calculated by the distance calculating unit 14 is within a predetermined range and the sign of the displacement of the boundary is reverse to the sign of the displacement of the pixel of interest during the calculation of the distance, the threshold value is corrected such that the sign thereof is reverse to the sign of the displacement of the pixel of interest.

In FIG. 4B, there are regions a, b, c, and d in which the distance is in a predetermined range. The region a is in a predetermined range from the boundary of white. In the region a, the sign of displacement at the boundary of white is negative and the sign of displacement when a pixel in the region a is the pixel of interest is also negative. Since the displacements have the same sign, the threshold value is not corrected. The region b is in a predetermined range from the black region. In the region b, since the ternarization result is not gray, the threshold value is not corrected. The region c is in a predetermined range from the white region. In the region c, since the ternarization result is not gray, the threshold value is not corrected.

The region d is in a predetermined range from the black region. In the region d, the sign of displacement at the boundary of black is positive and the sign of displacement when a pixel in the region d is the pixel of interest is negative and is reverse to the sign of displacement at the boundary of black. In this case, the threshold value is corrected such that the sign thereof is positive which is reverse to the negative sign of displacement.

In FIG. 4C, a variation in the color density shown in FIG. 4A and a variation in the selected and corrected threshold value are represented by a dashed line. The binarization result at the threshold value is shown in FIG. 4D. In the example of the binarization result, when the color density of the pixel of interest is equal to or less than the threshold value, white, which is one of two values, is selected. When the color density of the pixel of interest is more than the threshold value, black, which is the other one of the two values, is selected.

The region 1 includes a region in which the fixed threshold value is selected and a region in which the average value of the color density of the local region is selected as the threshold value. In each of the regions, the color density of the pixel of interest is equal to or less than the threshold value, and the binarization result is white. In the region 2, the average value of the color density of the local region is selected as the threshold value and the color density of the pixel of interest is more than the threshold value. Therefore, the binarization result is black. In the region 3, since the ternarization result is gray, the fixed threshold value is selected. Since the color density of the pixel of interest is more than the fixed threshold value, the binarization result is black. In the region d in the range from the boundary of the region 2, the fixed threshold value is corrected to the positive side. In the region d of the region 3, the color density of the pixel of interest is made equal to or less than the fixed threshold value by the correction and the region d is binarized to white. In FIG. 4D, the binary value is changed in a predetermined portion of the region 2 adjacent to the region 3, and this portion indicates that there is a boundary between the region 2 and the region 3.

In the above-described exemplary embodiment, in a predetermined range from the boundary of black or white, when the ternary value is gray, it is determined whether to correct the threshold value. However, when the ternary value is not gray, it may be determined whether to correct the threshold value. In this case, the ternary value is the white region adjacent to black or the black region adjacent to white. In the region, the sign of the displacement of the pixel at the boundary is reverse to that of the displacement of the pixel of interest, and the threshold value is corrected. However, since the threshold value is corrected such that the sign thereof is reverse to the sign of the displacement of the pixel of interest, the binarization result does not vary. For example, the binarization result that is white since the color density of the pixel of interest is equal to or less than the threshold value does not vary even when the threshold value is corrected to the positive side in the white region adjacent to black. The binarization result that is black since the color density of the pixel of interest is more than the threshold value does not vary even when the threshold value is corrected to the negative side in the black region adjacent to white.

In the above-described exemplary embodiment, in a predetermined range of the distance from the boundary of black or white, when the condition that the sign of the displacement of the boundary is reverse to that of the displacement of the pixel of interest during the calculation of the distance is satisfied, the threshold value is corrected. However, the invention is not limited thereto. For example, when the above-mentioned condition is satisfied from the boundary of black, the binarization result may be white. When the above-mentioned condition is satisfied from the boundary of white, the binarization result may be black.

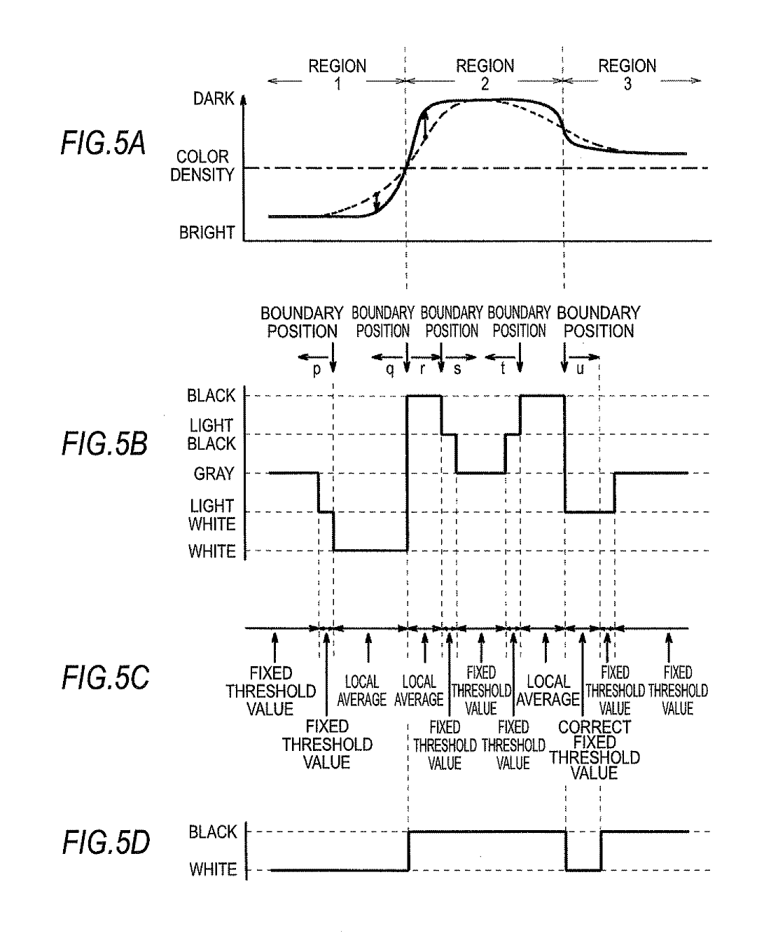

FIGS. 5A to 5D are diagrams illustrating another example of the operation of the second exemplary embodiment of the invention. FIG. 5A partially shows an example of a variation in color density in an image to be processed, and the variation in color density is represented by a solid line. In this example, a region 1, a region 2, and a region 3 have different colors. The color density of the region 1 is less than that of the region 2 and the region 3, and the color density of the region 2 is more than that of the region 1 and the region 3. A region 2 is extended as compared to an example in FIG. 4.

The operation of the displacement calculating unit 11 has been described in the example shown in FIGS. 4A to 4D, and calculates the difference between the average value of the color density of the local region shown in FIG. 5A which is represented by a dashed line and the value of the color density of the pixel of interest as displacement. In this example, when the color density of the pixel of interest is less than the average value, a sign “−” is given. When the color density of the pixel of interest is more than the average value, a sign “+” is given.

The N-arization unit 12 changes the displacement into an N-ary value (in this exemplary embodiment, a quinary value). The quinarization result is shown in FIG. 5B. In the example shown in FIG. 5B, five values are represented by white, light white, gray, light black, and black. In addition, black and white are the maximum and minimum values of the five values.

The distance calculating unit 14 calculates a specific N-ary value obtained by the N-arization unit 12. In this exemplary embodiment, the distance calculating unit 14 calculates the distance from the boundary between black and white to the pixel of interest. In FIG. 5B, the boundary position is represented by an arrow, and the distance calculating unit 14 calculates the distance from the boundary position to different quinary values.

The selection/binarization unit 13 selects a threshold value according to the quinary value and binarizes the value of the pixel of interest. In this exemplary embodiment, in the white and black regions among the five values, the average value of the color density of the local region is selected as the threshold value. In the gray region among the five values, a predetermined fixed threshold value is selected.

Light white and light black are basically gray, and a predetermined fixed threshold value is selected. In the light white region in a predetermined distance range from the boundary of black, the fixed threshold value is corrected to the positive side or the binarization result is set to white. In the light white region in a predetermined distance range from the boundary of black, the sign of displacement at the boundary of black is positive, and the sign of the displacement of the light white pixel of interest is negative which is reverse to the sign of displacement at the boundary of black. Therefore, the threshold value is corrected to the positive side, or the binarization result is set to white.

In the light black region in a predetermined distance range from the boundary of white, the fixed threshold value is corrected to the negative side or the binarization result is set to black. In the light black region in a predetermined distance range from the boundary of white, the sign of displacement at the boundary of white is negative, and the sign of the displacement of the light black pixel of interest is positive which is reverse to the sign of displacement at the boundary of white. Therefore, the threshold value is corrected to the negative side, or the binarization result is set to black.

In the light black region in a predetermined distance range from the boundary of black and the light white region in a predetermined distance range from the boundary of white, both the sign of displacement at the boundary and the sign of the displacement of the pixel of interest are positive or negative. Therefore, the conditions are not satisfied and the fixed threshold value is used without being corrected.

In the example of the quinarization result shown in FIG. 5B, there are six regions p, q, r, s, t, and u in a predetermined range from the boundary of white or black. Among the regions, in the region u, light white is adjacent to the boundary of black and the conditions are satisfied. In a portion of the region u in which the quinary value is light white, the fixed threshold value is corrected to the positive side for binarization, or the binarization result is set to white.

The selected threshold value is shown in FIG. 5C, and the binarization result is shown in FIG. 5D. In the example of the binarization result, when the color density of the pixel of interest is equal to or less than the threshold value, white, which is one of two values, is selected. When the color density of the pixel of interest is more than the threshold value, black, which is the other one of the two values, is selected.

In the region 1, the fixed threshold value is selected in regions in which the quinary value is gray and light white and the average value of the color density of the local region is selected as the threshold value in the white region. In each of the regions, the color density of the pixel of interest is equal to or less than the threshold value and the binarization result is white. In the region 2, the average value of the color density of the local region is selected as the threshold value in a region in which the quinary value is black and the fixed threshold value is selected in the light black and gray regions. In each of the regions, the color density of the pixel of interest is more than the threshold value and the binarization result is black.

In the region 3, the fixed threshold value is selected in a region in which the quinary value is gray and the color density of the pixel of interest is more than the threshold value. Therefore, the binarization result is black. In a region in which the quinary value is light white, the fixed threshold value is corrected to the positive side. In this exemplary embodiment, the corrected fixed threshold value is more than the color density of the pixel of interest and the binarization result is white. Instead of correcting the threshold value, the binarization result may be white. In FIG. 5D, the binary value is changed in a predetermined portion of the region 2 adjacent to the region 3, and this portion indicates that there is a boundary between the region 2 and the region 3.

In the above-described embodiment, in a predetermined range from the boundary of black or white other than light white and light black, the sign of displacement may be determined and the threshold value may be corrected when the conditions are satisfied. In the above-described exemplary embodiment, it may be determined whether the conditions are satisfied on the basis of the quinary values limited to light white and light black.

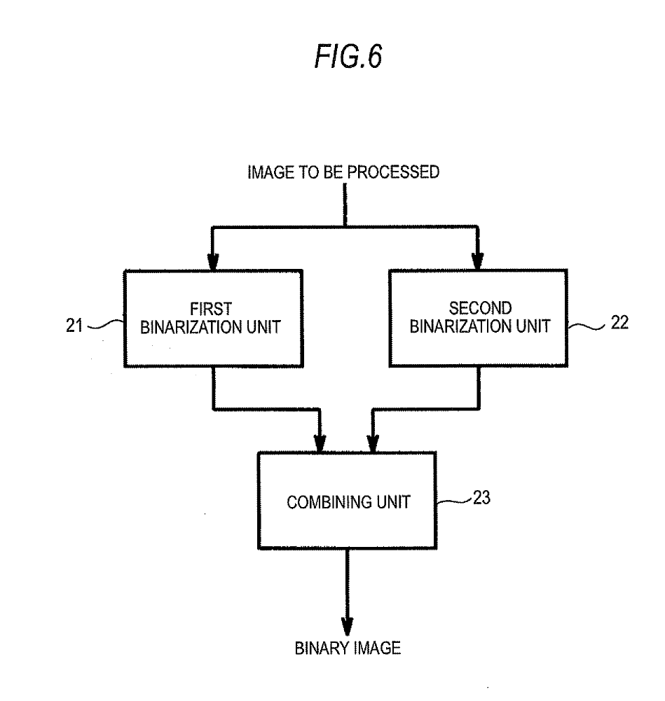

FIG. 6 is a diagram illustrating the structure of a third exemplary embodiment of the invention. In FIG. 6, reference numeral 21 indicates a first binarization unit, reference numeral 22 indicates a second binarization unit, and reference numeral 23 indicates a combining unit. The first binarization unit 21 binarizes a component of interest of an image to be processed. The same binarization method as that described in the first or second exemplary embodiment is used. The component of interest may be a brightness component. Components other than brightness may be used as the component of interest.

The second binarization unit 22 binarizes an auxiliary component of the image to be processed. The same binarization method as that described in the first or second exemplary embodiment is used. The auxiliary component may be a color difference component. Any component other than the component of interest may be used as the auxiliary component.

The combining unit 23 combines the binarization result obtained by the first binarization unit 21 with the binarization result obtained by the second binarization unit 22. During the combination, the binarization result obtained by the second binarization unit 22 is superimposed on a region in which there is no boundary in the binarization result obtained by the first binarization unit 21.

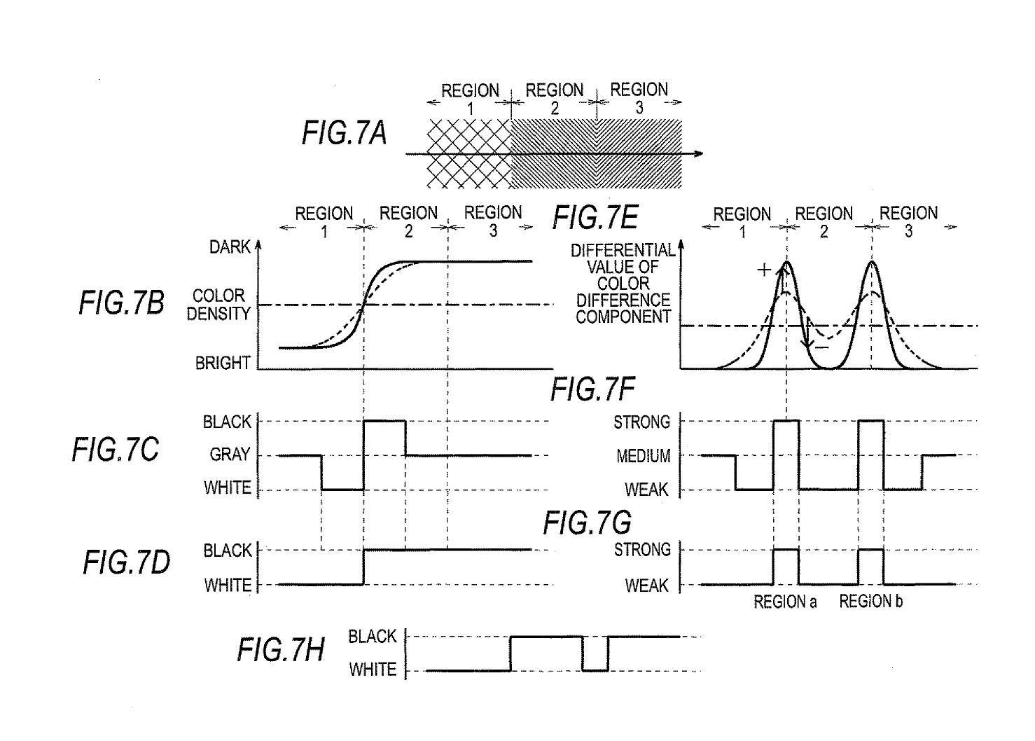

FIGS. 7A to 7H are diagrams illustrating an example of the operation of the third exemplary embodiment of the invention. FIG. 7A partially shows an example of an image to be processed. In the example, color difference components are different in a region 1, a region 2, and a region 3. The brightness of the region 1 is higher than that of the region 2 and the region 3 and there is no difference in brightness between the region 2 and the region 3. FIG. 7B shows a variation in the brightness component represented by an arrow in FIG. 7A. FIG. 7E shows a variation in the color difference component.

First, the first binarization unit 21 binarizes the brightness component using the same method as that described in the first exemplary embodiment. For the brightness component, the displacement of the value of the pixel of interest in a local region is calculated and the displacement is ternarized. In this way, the ternarization result shown in FIG. 7C is obtained. In the black and white regions among three values, the average value of the color density of the local region is selected as the threshold value, and the value of the pixel of interest is binarized. In the gray region among the three values, a predetermined fixed threshold value is selected and the value of the pixel of interest is binarized. The binarization result is shown in FIG. 7D.

The second binarization unit 22 binarizes the color difference component using the same method as that described in the first exemplary embodiment. In this example, the second binarization unit 22 calculates the absolute value of the differential value of the color difference component and calculates a local average value, which is the average value of the differential value in a predetermined range. In FIG. 7E, the differential value (absolute value) of the color difference component is represented by a solid line and the local average value is represented by a dashed line. The difference between the local average value and the differential value of the color difference component of the pixel of interest is used as the displacement. In FIG. 7E, a displacement in two pixels of interest is represented by an arrow. The sign of the displacement is negative when the differential value of the color difference component of the pixel of interest is less than the local average value, and is positive when the differential value of the color difference component of the pixel of interest is more than the local average value.

In this exemplary embodiment, the displacement obtained in this way is ternarized. The ternarization result is shown in FIG. 7F. In FIG. 7F, three values are represented by weak, medium, and strong values. In regions with the weak and strong values among the three values, the local average value of the differential value of the color difference component is selected as the threshold value, and the differential value of the color difference component of the pixel of interest is binarized. In a region with the medium value, a fixed threshold value is selected, and the differential value of the color difference component of the pixel of interest is binarized. An example of the fixed threshold value is represented by a one-dot chain line in FIG. 7E. The binarization result obtained using the threshold values selected in each region is shown in FIG. 7G.

The combining unit 23 combines the binarization result obtained by the first binarization unit 21 shown in FIG. 7D and with the binarization result obtained by the second binarization unit 22 shown in FIG. 7G. During the combination, the binarization result obtained by the second binarization unit 22 is superimposed on a region in which there is no boundary in the binarization result obtained by the first binarization unit 21 shown in FIG. 7D. The combination is not performed in the vicinity (region a) of the boundary between the region 1 and the region 2 in FIG. 7G since the binary value is inverted in FIG. 7D. For the vicinity (region b) of the boundary between the region 2 and the region 3 in FIG. 7G, since the binary value is not inverted in FIG. 7D, the binarization result of FIG. 7D corresponding to the vicinity (region b) of the boundary between the region 2 and the region 3 is inverted. The obtained combination result is shown in FIG. 7H. In the binarization result of the brightness component shown in FIG. 7D, the region 2 is not discriminated from the region 3. However, the region is discriminated from the region 3 by reflecting the binarization result obtained from the color difference component shown in FIG. 7G and the binarization result is obtained.

In this exemplary embodiment, the component of interest is the brightness component, and the auxiliary component is the color difference component. However, the invention is not limited thereto. Components that are desired to be specified in a binary image may be the component of interest and the auxiliary component. In this exemplary embodiment, the first binarization unit 21 and the second binarization unit 22 have the same structure as those in the first exemplary embodiment, but the invention is not limited thereto. One or both of the first binarization unit 21 and the second binarization unit 22 have the same structure as those in the second exemplary embodiment.

For example, when a YCrCb color system is used, there are Cr and Cb as the color difference components. In this case, the binarizing process according to the above-described exemplary embodiments may be performed from the absolute value of the differential value of each of the color difference components, and a process of superimposing the binarization results (a process of obtaining a “weak” value when both the binarization results are “weak” and obtaining a “strong” value when either of the binarization results is “strong”) may be performed to obtain the binarization result by the first binarization unit 21. As another method, the absolute values of the differential values of the color difference components may be added and the binarizing process according to the above-described exemplary embodiments may be performed from the addition result to obtain the binarization result by the first binarization unit 21. In addition, the color difference component may be used instead of the absolute value of the differential value of the color difference component.

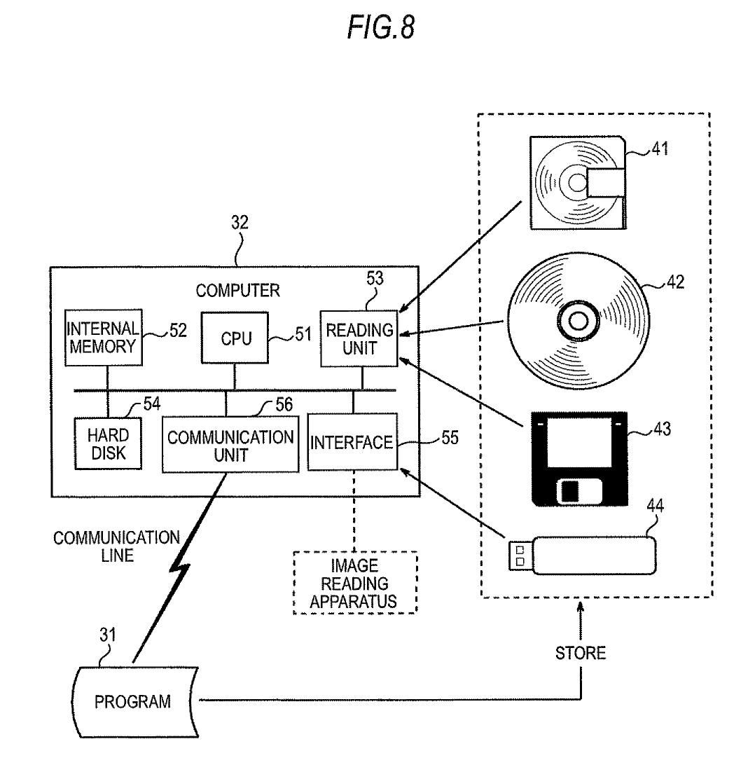

FIG. 8 is a diagram illustrating an example of a computer program for implementing the functions according to each of the above-described exemplary embodiments of the invention, a storage medium that stores the computer program, and a computer. In FIG. 8, reference numeral 31 indicates a program, reference numeral 32 indicates a computer, reference numeral 41 indicates a magneto-optical disc, reference numeral 42 indicates an optical disc, reference numeral 43 indicates a magnetic disk, reference numeral 44 indicates a memory, reference numeral 51 indicates a CPU, reference numeral 52 indicates an internal memory, reference numeral 53 indicates a reading unit, reference numeral 54 indicates a hard disk, reference numeral 55 indicates an interface, and reference numeral 56 indicates a communication unit.

The program 31 may allow the computer to implement all or some of the functions of each unit according to the above-described exemplary embodiments of the invention and the modifications thereof. In this case, for example, the program and data used by the program may be stored in a computer-readable storage medium. The storage medium causes a change in the state of energy, such as magnetism, light, or electricity, in the reading unit 53 provided in the hardware resources of the computer according to the description content of the program, and transmits the description content of the program to the reading unit 53 in the format of signals corresponding to the change in the state. Examples of the storage medium include the magneto-optical disc 41, the optical disc 42 (including, for example, CD or DVD), the magnetic disk 43, and the memory 44 (including, for example, an IC card, a memory card, and a flash memory). These storage media are not limited to a portable type.

The program 31 is stored in the storage medium and the storage medium is inserted into, for example, the reading unit 53 or the interface 55 of the computer 32. Then, the computer reads the program 31 and stores the read program in the internal memory 52 or the hard disk 54 (including, for example, a magnetic disk or a silicon disk). The CPU 51 executes the program 31 to implement all or some of the functions according to each exemplary embodiment of the invention and the modifications thereof. Alternatively, the program 31 may be transmitted to the computer 32 through the communication line, the computer 32 may receive the program 31 using the communication unit 56 and store the program in the internal memory 52 or the hard disk 54, and the CPU 51 may execute the program 31 to implement all or some of the functions.

Various kinds of devices may be connected to the computer 32 through the interface 55. For example, a display unit that displays information or a receiving unit that receives information from the user may be connected to the computer 32. In addition, for example, an image reading apparatus may be connected to the computer 32 through the interface 55 and an image read by the image reading apparatus or an image subjected to image processing may be processed by the process according to each exemplary embodiment of the invention and the modifications thereof. The processed binary image may be transmitted to another program and then stored in the hard disk 54 or in a storage medium through the interface 55, or it may be transmitted to the outside through the communication unit 56. An image forming apparatus may be connected to the computer through the interface 55 and form the processed binary image.

Some or all of the functions may be formed by hardware. Alternatively, all or some of the functions according to each exemplary embodiment of the invention and the modifications thereof and other structures may be implemented by programs. When the program is applied to other purposes, the program may be integrated with programs for other purposes.

The foregoing description of the exemplary embodiments of the invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention is defined by the following claims and their equivalents.

What is claimed is:

1. A binarizing device comprising:
a displacement calculating unit that calculates a displacement of a value of a pixel of interest in a local region which includes the pixel of interest and indicates a predetermined range;
an N-arization unit that changes the displacement calculated by the displacement calculating unit to an N-ary value; and
a selection/binarization unit that selects at least one of a fixed value or an average value of the local region as a threshold value according to the N-ary value obtained by the N-arization unit and binarizes the value of the pixel of interest.

2. The binarizing device according to claim 1, further comprising:
a distance calculating unit that calculates a distance from a specific N-ary value obtained by the N-arization unit to the pixel of interest,
wherein the selection/binarization unit selects the threshold value according to the N-ary value obtained by the N-arization unit and the distance calculated by the distance calculating unit.

3. An image processing apparatus comprising:
a first binarization unit that has a structure of the binarizing device according to claim 1 and binarizes a component of interest of an image to be processed;
a second binarization unit that has a structure of the binarizing device according to claim 1 and binarizes an auxiliary component of the image; and
a combining unit that combines a binarization result obtained by the first binarization unit with a binarization result obtained by the second binarization unit.

4. The image processing apparatus according to claim 3,
wherein the combining unit superimposes the binarization result obtained by the second binarization unit on a region in which no boundary exists in the binarization result obtained by the first binarization unit.

5. A non-transitory computer readable medium storing a program causing to a computer to execute a process for binarizing,
the process comprising:
calculating displacement of a value of a pixel of interest in a local region which includes the pixel of interest and indicates a predetermined range;
changing the displacement calculated by the displacement calculating unit to an N-ary value; and
selecting at least one of a fixed value or an average value of the local region as a threshold value according to the N-ary value obtained by the N-arization unit and binarizing the value of the pixel of interest.

6. A computer data signal embodied in a carrier wave for enabling a computer to perform a process for binarizing,
the process comprising:
calculating displacement of a value of a pixel of interest in a local region which includes the pixel of interest and indicates a predetermined range;
changing the displacement calculated by the displacement calculating unit to an N-ary value; and
selecting at least one of a fixed value or an average value of the local region as a threshold value according to the N-ary value obtained by the N-arization unit and binarizing the value of the pixel of interest.

7. A method for binalizing, comprising:
calculating displacement of a value of a pixel of interest in a local region which includes the pixel of interest and indicates a predetermined range;
changing the displacement calculated by the displacement calculating unit to an N-ary value; and
selecting at least one of a fixed value or an average value of the local region as a threshold value according to the N-ary value obtained by the N-arization unit and binarizing the value of the pixel of interest.
